(19) United States
(12) Patent Application Publication
(10) Pub. No.: US 2013/0253386 A1
(43) Pub. Date: Sep. 26, 2013

(54) MASSAGE APPARATUS WITH A CONFIGURABLE STIMULATOR SLEEVE

(71) Applicant: Simon Siu Man Nan, Richmond Hill (CA)

(72) Inventor: Simon Siu Man Nan, Richmond Hill (CA)

(73) Assignee: Nanma Manufacturing Co., Ltd., Hong Kong (CN)

(21) Appl. No.: 13/427,565

(22) Filed: Mar. 22, 2012

(51) Int. Cl. A61H 1/00; B23P 11/00

(52) U.S. Cl. 601/46; 29/428

(57) ABSTRACT

A massage apparatus having a vibrator component engaged within a configurable stimulator sleeve is disclosed. The configurable stimulator sleeve defines a proximal portion having an opening in communication with an interior channel configured to receive the vibrator component therein and a flexible distal portion that is manually configurable to a assume one or more different configurations such that the flexible distal portion directly imparts a vibration effect generated by the vibrator component to different anatomical portions of an individual based on the particular configuration assumed by the configurable stimulator sleeve.

### FIELD

This document relates to a massage apparatus, and in particular to a massage apparatus having a flexible stimulator sleeve that is configurable.

### BACKGROUND

Typically, a massage apparatus may include a vibrator body that encases a vibrator component that generates vibrations at different predetermined strengths and patterns. Such massage apparatuses may also have a proximal portion that includes a control panel for controlling the operation of the massage apparatus and a solid distal portion defining a solid elongated tapered or spherical shape. Although these types of massage apparatuses perform well for their intended purpose, the fixed configuration of the solid distal portion limits the area in which the massage apparatus may be able to apply vibrations directly to particular areas of the female sexual organ, for example the clitoris. As such, there is a need in the art for a massage apparatus that provides an improvement to these massage apparatuses in which a configurable stimulator sleeve that is engaged to the body of the massage apparatus and is manually configurable to assume different types of configurations and appearances for enhancing the individual's experience with the massage apparatus.

### SUMMARY

In an embodiment, a massage apparatus may include a vibrator component defining a proximal portion and a distal portion, wherein the vibrator component generates a vibration effect. A configurable stimulator sleeve may include a sleeve body including a proximal portion defining an opening in communication with an internal channel formed within the sleeve body which is configured to receive the vibrator component for generating a vibration effect and a flexible distal portion made from a flexible material to allow the flexible distal portion to assume one or more different configurations.

In another embodiment, a method of manufacturing a massage apparatus may include:
forming a configurable stimulator sleeve having a sleeve body defining a flexible distal portion and a proximal portion, wherein the flexible distal portion defines a top part, a bottom part, a first side part, and a second side part that collectively form an opening, and wherein the proximal portion is formed with an opening in communication with a channel defined along a length of the sleeve body, wherein the flexible distal portion is configured to assume one or more different configurations;
assembling a vibrator component having a vibrator motor for generating a vibration effect, a control interface for controlling the operation of the vibrator motor, and a power source in operative communication with the control interface and the vibrator motor for controlling the operation of the massage apparatus; and
disposing the vibrator component within the channel of the configurable stimulator sleeve.

In yet another embodiment, a method of using a massage apparatus may include:
providing a massage apparatus comprising:
   a vibrator component defining a proximal portion and a distal portion, wherein the vibrator component includes a vibration means for generating a vibration effect; and
   a configurable stimulator sleeve having a sleeve body defining a flexible distal portion and a proximal portion, wherein the distal end forms a top part, a bottom part, a first side part, and a second side part that collectively define an opening, and wherein the proximal portion forms an opening in communication with a channel defined along a length of the sleeve body, wherein the proximal portion defines an opening in communication the chamber, wherein the flexible distal portion has a non-configured state and a configured state, wherein the configured state the flexible distal portion is configured to assume one or more different configurations; and
configuring the flexible distal portion such that the top part, the bottom part, the first side part, the second side part and the opening assume a configured state.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a perspective view of the massage apparatus;

FIG. 2 is an exploded view of the massage apparatus showing the vibrator component and configurable stimulator sleeve;

FIG. 3 is another exploded view of the massage apparatus showing the internal components of the vibrator component;

FIGS. 4A-4G illustrate a sequence for manipulating the configurable stimulator sleeve to assume different configurations;

FIG. 5 is a flow chart that illustrates one method for manufacturing the massage apparatus; and

FIG. 6 is a flow chart that illustrates one method for using the configurable stimulator sleeve.

Corresponding reference characters indicate corresponding elements among the various views of the drawings. The headings used in the figures should not be interpreted to limit the scope of the claims.

### DETAILED DESCRIPTION

A massage apparatus having a vibrator component engaged to a configurable stimulator sleeve and related method of manipulating the configurable stimulator sleeve to assume different configurations is disclosed. The ability to configure the configurable stimulator sleeve into different configurations permits the massage apparatus to provide direct vibratory stimulation to different anatomical portions of an individual based on a particular configuration assumed by the configurable stimulator sleeve.

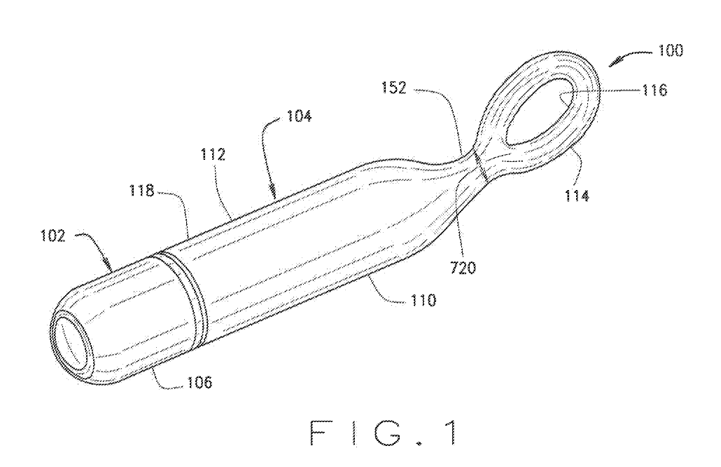

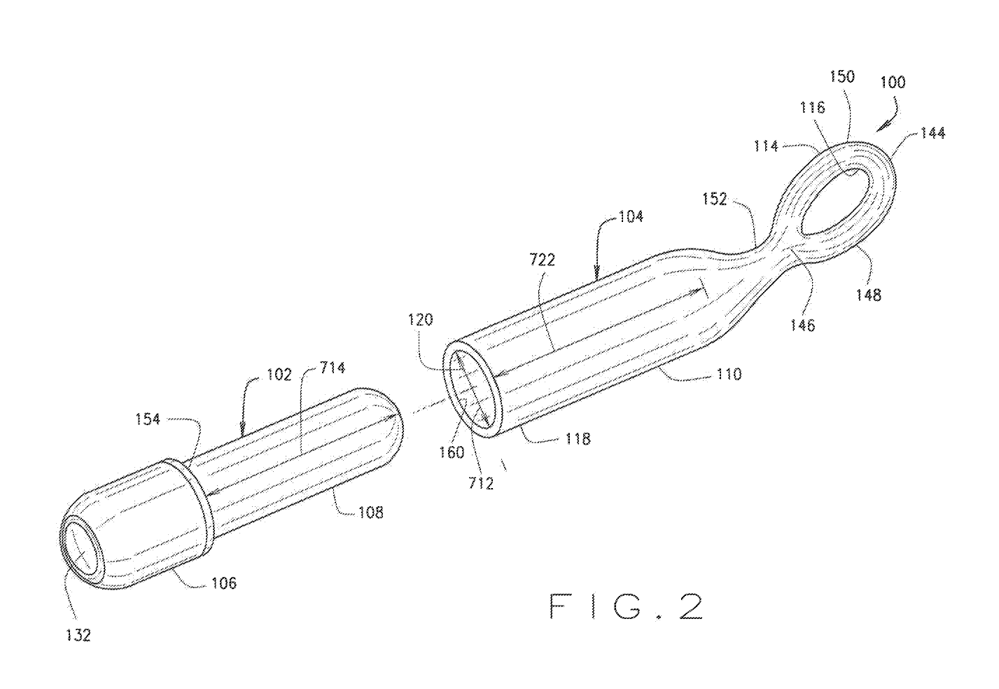

Referring to the drawings, an embodiment of the massage apparatus is illustrated and generally indicated as 100 in FIGS. 1-4. Referring to FIGS. 1 and 2, the massage apparatus 100 includes a vibrator component 102 for providing a vibration effect engaged to a flexible stimulator sleeve 104 that may be manipulated by an individual to assume and retain different configurations. The vibrator component 102 defines a solid proximal portion 106 having a control interface 132 for controlling the vibrator functions of the vibrator component 102 and an elongated distal portion 108 configured to engage and be disposed within the configurable stimulator sleeve 104 such that the vibration effects generated by the vibrator component 102 are imparted through the configurable stimulator sleeve 104.

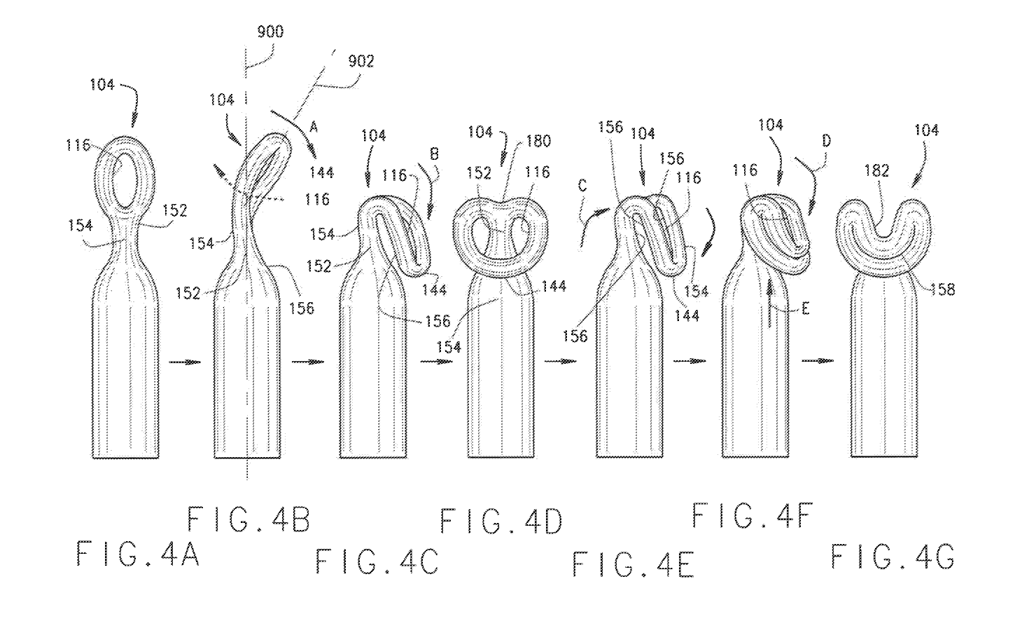

As illustrated in FIG. 2, in one embodiment the configurable stimulator sleeve 104 defines an elongated tubular-shaped sleeve body 110 defining a distal portion 114 and a proximal portion 118 as well as a front surface 154 (FIGS. 4A-C) and a rear surface 156 (FIGS. 4B and 4C). The end of the proximal portion 118 of the configurable stimulator sleeve 104 defines an opening 160 in communication with an internal channel 120 configured to receive and engage the distal portion 108 of the vibrator component 102 when assembling the massage apparatus 100. The flexible distal portion 114 of the configurable stimulator sleeve 104 defines a top part 144, a bottom part 146, a first side part 148, and a second side part 150 that collectively form an opening 116 which is configurable to assume different configurations. When the flexible distal portion 114 is in the normal, non-configured state the opening 116 may have a generally circular-shaped configuration, a generally oval-shaped configuration, a generally irregular-shaped configuration, a generally symmetrically-shaped configuration, a generally asymmetrical configuration, and a combination thereof. As further shown, the bottom part 146 of the distal portion 114 communicates with the proximal portion 118 of the sleeve body 110 through a flexible neck portion 152 that may be bent at various orientations when manually manipulated. Moreover, the configurable stimulator sleeve 104 may be made from a flexible material, for example silicone, that is sufficiently elastic and flexible to permit the distal portion 114 to assume different configurations when manipulated, such as by an individual. These different configurations that may be assumed by the flexible distal portion 114 are manually configured by an individual to apply vibrations generated by the vibrator component 102 directly to different anatomical portions of the individual's sexual organ, such the clitoris and surrounding tissue of the vaginal area. In other embodiments, the flexible stimulator sleeve 104 may be made from a rubber-like material, an elastic-like material, a flexible metallic material, a flexible memory-retaining metallic material, and a combination thereof. In some embodiments, the flexible neck portion 152 may be bent in various orientations, while the top part 144, bottom part 146, first side part 148, and second side part 150 of the flexible distal portion 114 may bent at various orientations to assume and retain different configurations.

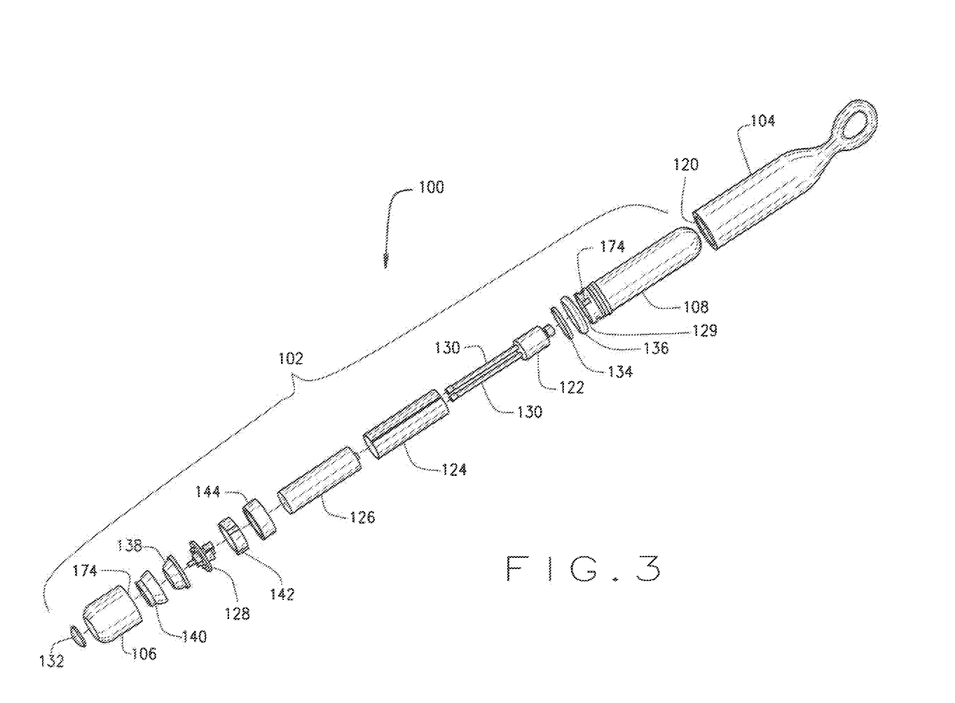

Referring to FIG. 3, an exploded view of the vibrator component 102 is illustrated. The distal portion 108 of the vibrator component 102 defines an interior chamber 129 configured to house the various parts of the vibrator component 102. As shown, the vibrator component 102 includes a vibrator motor 122 having a rotating shaft (not shown) that rotates an eccentric mass 131 for generating the vibration effect during operation of the vibrator component 102. The vibrator motor 122 further includes positive and negative electrical leads 130 that extend outwardly from the vibrator motor 122 and are in operative communication with a battery 126 for providing power to the vibrator motor 122. In addition, a motor sleeve 124 is configured to house the vibrator motor 122 within the internal chamber 129 of the vibrator component 102. In some embodiments, a retaining ring 136 is configured to engage a flange 170 formed around the circumference of the distal portion 108 during the assembly of the vibrator component 102. A sealing element 134, such as a rubber O-ring, may be engaged with the retaining ring 136 to provide a water-tight seal when the vibrator component 102 is assembled. In some embodiments, the vibrator component 102 defines a shoulder 154 between the proximal portion 106 and the distal portion 108 that is configured to abut the end of the sleeve body 110 when the distal portion 108 is received within the chamber 120 of the flexible stimulator sleeve 104.

As further shown, the proximal portion 106 of the vibrator component 102 defines an open-ended chamber 174 configured to house the components that control the operation of the massage apparatus 100, and in particular the operation of the vibrator motor 122. A circuit board 128 is in operative association with the control interface 132 for controlling the operation of the vibrator motor 122. In some embodiments, the circuit board 128 turns the vibrator motor 122 between the OFF and ON operational states when the control interface 132 is actuated by an individual. The circuit board 128 may also allow the vibrator motor 122 to generate vibrations of varying intensity, sequences and patterns. For example, the circuit board 128 may control the vibrator motor 122 to generate vibration intensities of LOW, MODERATE and HIGH intensity as well as different sequences of vibration intensities. In addition, the circuit board 128 may allow the vibrator component 102 to generate vibration patterns that begin at LOW vibration intensity, transition to MODERATE vibration intensity, and then achieve HIGH vibration intensity over a predetermined time period and pattern arrangements during the operation of the vibrator component 102. Other vibration patterns produced by the vibrator motor 122 may vary in intensity, sequence of intensity, vibration activity, and duration of each vibration activity; however, the vibration patterns, intensities and durations produced by the vibrator component 102 are not limited in this regard.

When assembling the vibrator component 102, the circuit board 128 may be engaged to a seat 138 that is configured to couple with a platform 140 that is disposed within the chamber 174 of the proximal portion 106 of the vibrator component 102. In some embodiments, a locking ring 142 may be disposed within a bushing 144 adjacent or proximate the proximal portion 106 of the vibrator component 102 with the locking ring 142 being configured to engage and secure with a slot and groove arrangement 172 defined round the circumference of the distal portion of the vibrator component 102.

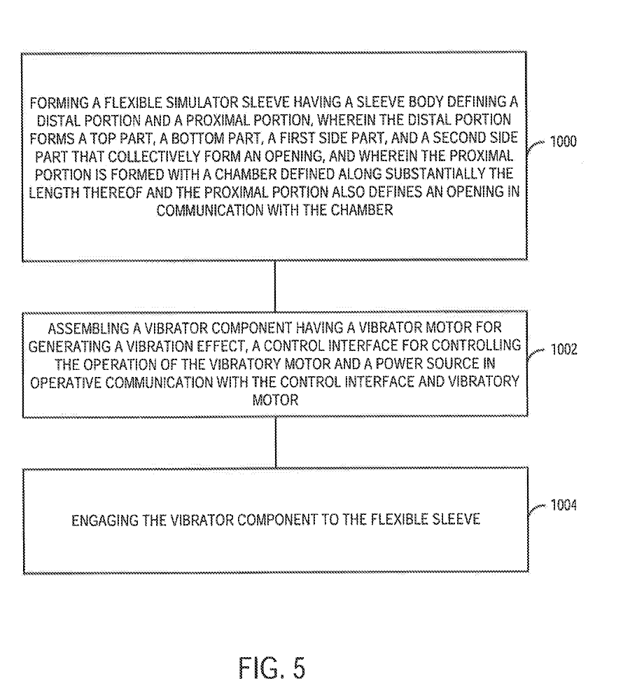

Referring to FIG. 5, a flow chart is illustrated that shows one method for manufacturing the massage apparatus 100. At block 1000, forming a configurable stimulator sleeve 104 having a sleeve body 110 defining a flexible distal portion 114 and a proximal portion 118, wherein the flexible distal portion 114 forms a top part 144, a bottom part 146, a first side part 148, and a second side part 150 that collectively form an opening 116 configurable to assume one or more configurations, and wherein the proximal portion 118 forms an opening 160 in communication with a channel 120 defined along a length of the sleeve body 110. At block 1002, assembling a vibrator component 102 having a vibrator motor 122 for generating a vibration effect, a control interface 132 for controlling the operation of the vibrator motor 122, and a power source, such as a battery 126, in operative communication with the control interface 132 and the vibrator motor 122. At block 1004, engaging the vibrator component 102 to the configurable stimulator sleeve 104 by inserting the vibrator component 102 within the channel 120 of the configurable stimulator sleeve 104.

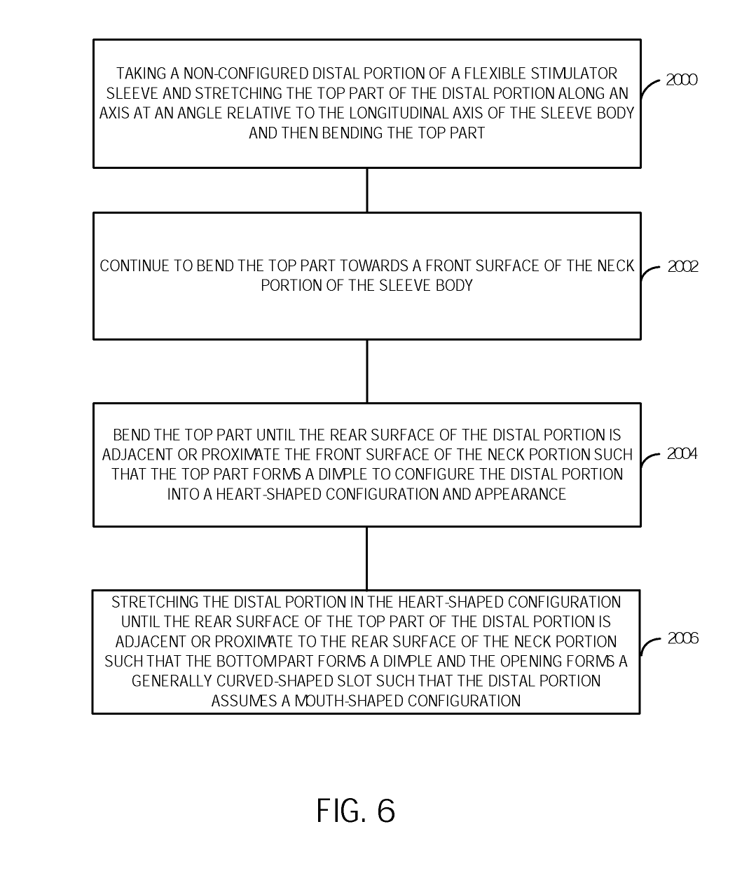

Referring to FIG. 6, a flow chart is illustrated that shows one method for configuring the flexible distal portion 114 of the configurable stimulator sleeve 104 to different configurations such that each particular configuration is configured to directly stimulate different anatomical parts of an individual when the configured flexible distal portion 114 is applied to a portion of the female sexual organ, such as the clitoris or surrounding vaginal tissue. At block 2000, taking a flexible distal portion 114 (FIG. 4A) in the non-configured state and stretching the top part 144 of the flexible distal portion 114 (FIG. 4B) along an axis 902 at an angle 904 relative to the longitudinal axis 900 of the sleeve body 110 and then bending the top part 144 of the distal portion 114 in the A direction. At block 2002, continuing to bend the top part 144 from axis 902 towards the front surface 154 of the neck portion 152 in the B direction (FIG. 4C). At block 2004, the top part 144 (FIG. 4D) is bent until the rear surface 156 of the distal portion 114 is adjacent or proximate the front surface 154 of the neck portion 152 and the top part 144 forms a slight dimple 180 such that the flexible distal portion 114, collectively forms a generally heart-shaped configuration and appearance as shown in FIG. 4D. At block 2006, the distal portion 114 which is in the generally-heart shaped configuration shown in FIG. 4D is further stretched and bent in the C direction (FIG. 4E) and then the D and E directions (FIG. 4F) until the rear surface 156 of the top part 144 is proximate or adjacent to the rear surface 156 of the neck portion 152 such that the bottom part 146 forms a dimple 182, and the opening 116 forms a generally curved-shaped slot 158 such that the flexible distal portion 114 is now configured to assume a substantially mouth-shaped configuration and appearance as illustrated in FIG. 4G from the generally heart-shaped configuration shown in FIG. 4D.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A massage apparatus comprising:
a vibrator component defining a proximal portion and a distal portion, wherein the vibrator component generates a vibration effect; and
a configurable stimulator sleeve having a hollow sleeve body including a proximal portion defining an opening in communication with an internal channel formed within the sleeve body configured to receive the vibrator component for generating a vibration effect and a flexible distal portion made from a flexible material to allow the flexible distal portion to assume one or more different configurations.

2. The massage apparatus of claim 1, wherein the flexible distal portion defines an opening.

3. The massage apparatus of claim 1, wherein the distal portion defines a top part, a bottom part, a first side part, and a second side part that collectively form the opening.

4. The massage apparatus of claim 1, wherein the vibrator component comprises a vibrator motor having a rotating shaft that rotates an eccentric mass to generate the vibration effect.

5. The massage apparatus of claim 1, wherein the vibrator component defines a distal portion that forms a shoulder with the proximal portion configured to be received within the internal channel of the configurable stimulator sleeve.

6. The massage apparatus of claim 1, wherein the configurable stimulator sleeve further comprises a neck portion defined between the proximal portion and the distal portion, wherein the neck portion is bendable to one or more orientations.

7. The massage apparatus of claim 2, wherein the flexible distal portion is configured to define a dimple along a portion of the flexible distal portion.

8. The massage apparatus of claim 1, wherein the configurable stimulator sleeve is made from at least of a silicone material, a rubber material, a bendable metallic material, and a bendable memory-retaining material.

9. The massage apparatus of claim 1, wherein the distal portion of the flexible sleeve has a non-configured configuration defining at least a circular configuration, an oval-shaped configuration, a symmetrical-shaped configuration, and a non-symmetrical-shaped configuration.

10. The massage apparatus of claim 1, wherein the flexible distal portion of the configurable stimulator sleeve is configured to assume at least a mouth-shaped appearance or a heart-shaped appearance.

11. A method of manufacturing a massage apparatus comprising:
forming a configurable stimulator sleeve having a sleeve body defining a flexible distal portion and a proximal portion, wherein the flexible distal portion defines a top part, a bottom part, a first side part, and a second side part that collectively form an opening, and wherein the proximal portion is formed with an opening in communication with a channel defined along a length of the sleeve body, wherein the flexible distal portion is configured to assume one or more different configurations;
assembling a vibrator component having a vibrator motor for generating a vibration effect, a control interface for controlling the operation of the vibrator motor, and a power source in operative communication with the control interface and the vibrator motor for controlling the operation of the massage apparatus; and
disposing the vibrator component within the channel of the configurable stimulator sleeve.

12. The method of claim 11, wherein the configurable stimulator sleeve is made from at least a silicone material, a rubber material, a bendable metallic material, and a bendable memory-retaining material.

13. The method of claim 11, wherein assembling the vibrator component comprises the vibrator motor including a rotating shaft engaged to an eccentric mass that generates the vibration effect when the eccentric mass is rotated by the rotating shaft when driven by the vibrator motor.

14. The method of claim 11, wherein the control interface is a switch for activating and deactivating the power source to the vibrator motor.

15. A method of using a massage apparatus comprising:
providing a massage apparatus comprising:
a vibrator component defining a proximal portion and a distal portion, wherein the vibrator component includes a vibration means for generating a vibration effect; and
a configurable stimulator sleeve having a sleeve body defining a flexible distal portion and a proximal portion, wherein the distal end forms a top part, a bottom part, a first side part, and a second side part that collectively define an opening, and wherein the proximal portion forms an opening in communication with a channel defined along a length of the sleeve body, wherein the proximal portion defines an opening in communication the chamber, wherein the flexible distal portion has a non-configured state and a configured state, wherein the configured state the flexible distal portion is configured to assume one or more different configurations; and
configuring the flexible distal portion such that the top part, the bottom part, the first side part, the second side part and the opening assume a configured state.

16. The method of claim 15, further comprising configuring the flexible distal portion such that a dimple is formed.

17. The method of claim 16, further comprising configuring the flexible distal portion to assume a configured state having a generally heart-shaped appearance.

18. The method of claim 17, further comprising configuring the flexible distal portion from the generally heart-shaped appearance to a generally mouth-shaped appearance.

19. The method of claim 15, further comprising positioning the massage apparatus in the same orientation relative to an individual such that a different anatomical part of an individual received a direct vibration effect from the configurable stimulator sleeve based on a particular configuration of the flexible distal portion.

20. The method of claim 18, wherein the opening defines a generally curved slit when the flexible distal portion forms the generally mouth-shaped appearance.
